(19) United States
(12) Patent Application Publication
(10) Pub. No.: US 2019/0241353 A1
(43) Pub. Date: Aug. 8, 2019

(54) PIPE COIL SKID AND METHOD OF USE

(71) Applicant: FlexSteel Pipeline Technologies, Inc., Houston, TX (US)

(72) Inventors: Max REEDY, Kemah, TX (US); Alex WINN, Spring, TX (US); Peter PARKER, Beech Creek, PA (US)

(21) Appl. No.: 16/319,882

(22) PCT Filed: Jun. 23, 2017
(86) PCT No.: PCT/US17/39104

§ 371 Date: Jan. 23, 2019

Related U.S. Application Data
(60) Provisional application No. 62/356,397, filed on Jun. 29, 2016.

(51) Int. Cl. B65D 85/04; B21C 47/22; B60P 3/035; B60P 7/12; B65D 19/00; B65D 19/44

(52) U.S. Cl. CPC B65D 85/04; B65D 2519/0096; B60P 3/035; B60P 7/12; B65D 19/0048; B65D 19/44; B65D 2519/00024; B65D 2519/00059; B65D 2519/00273; B65D 2519/00288; B65D 2519/00323; B65D 2519/00333; B65D 2519/00562; B65D 2519/00815; B21C 47/22

(57) ABSTRACT

A pipe coil skid comprises a plurality of beams affixably connected together to form a rectangular shaped base with a platform disposed within the base, the platform having a concave upward shape on its upward facing side when the skid sits on a horizontal surface such that the coil of pipe positioned upon the platform contacts the platform within the base. In other aspects, the pipe coil skid has an upward facing side generally corresponding to the outer circumferential shape of a coil of pipe. The beams and the platform may be formed of a steel material. The platform may be coated with a non-stick material or a rubberized material. The pipe coil skid may have a plurality of tie-down points for securing the coil of pipe. The pipe coil skid may have stackable corners disposed on the skids to enable stacking of pipe coil skids.

### BACKGROUND

Flexible pipe is useful in a myriad of environments, including in the oil and gas industry. Flexible pipe may be durable and operational in harsh operating conditions and can accommodate high pressures and temperatures. Flexible pipe may be bundled and arranged into one or more coils to facilitate transporting and using the pipe.

Coils of pipe may be positioned in an “eye to the side” or “eye to the sky” orientation. When the flexible pipe is coiled and is disposed with its interior channel facing upwards, such that the coil is in a horizontal orientation, then the coils of pipe are referred to as being in an “eye to the sky” orientation. If, instead, the flexible pipe is coiled and disposed such that the interior channel is not facing upwards, such that the coil is in an upright or vertical orientation, then the coils of pipe are referred to as being in an “eye to the side” orientation.

The flexible pipe may be transported as coils to various sites for deployment (also referred to as uncoiling or unspooling). Different types of devices and vehicles are currently used for loading and transporting coils of pipe, but usually extra equipment and human manual labor is also involved in the process of loading or unloading such coils for transportation and/or deployment. Such coils of pipe are often quite large and heavy. Accordingly, there exists a need for an improved method and apparatus for loading, moving and unloading coils of pipe.

### SUMMARY

Various nonlimiting embodiments provide methods and apparatuses for moving coils of flexible pipe using a pipe coil skid. A pipe coil skid comprises a plurality of beams affixably connected together to form a rectangular shaped base with a platform disposed within the base, the platform having a concave upward shape on its upward facing side when the skid sits on a horizontal surface such that the coil of pipe positioned upon the platform contacts the platform within the base. In other aspects, the pipe coil skid has an upward facing side generally corresponding to the outer circumferential shape of a coil of pipe. The beams and the platform may be formed of a steel material. The platform may be coated with a non-stick material or a rubberized material. The pipe coil skid may have a plurality of tie-down points for securing the coil of pipe. The pipe coil skid may have stackable corners disposed on the skids to enable stacking of pipe coil skids.

In other nonlimiting embodiments, a method for using a pipe coil skid comprising: securing a coil of pipe to a pipe coil skid, the skid comprising a plurality of beams affixably connected together to form a rectangular shaped base, and a platform disposed within the base, the platform having a concave upward shape on its upward facing side when the skid sits on a horizontal surface, such that the coil of pipe positioned upon the platform contacts the platform within the base. The coil may be lifted using a pipe coil lifting device disposed on a fork lift, a pipe coil lifting device secured by cable to a crane, an installation trailer for coiled pipe, or an expandable drum assembly for deploying coiled pipe. The skid may have an upward facing side generally corresponding to the outer circumferential shape of a coil of pipe. The beams and the platform are formed of a steel material and the platform may be coated with a non-stick material or a rubberized material. The pipe coil is secured to the skid using straps. The coil and skid may be secured to a rail car. The skids may be stacked.

### BRIEF DESCRIPTION OF THE DRAWINGS

A better understanding of the present invention can be obtained when the following detailed description of the preferred embodiment is considered in conjunction with the following drawings, in which:

FIG. 1 is a diagram of a coil of pipe secured with straps on a pipe coil skid according to embodiments of the present disclosure;

FIG. 2 is an illustration of a coil of pipe on a pipe coil skid according to embodiments of the present disclosure;

FIG. 3 illustrates a pipe coil skid according to embodiments of the present disclosure;

FIG. 4 illustrates a pipe coil skid according to embodiments of the present disclosure;

FIG. 5 illustrates aspects of a pipe coil skid according to embodiments of the present disclosure;

FIG. 6 illustrates aspects of a pipe coil skid according to embodiments of the present disclosure;

FIG. 7 illustrates aspects of a pipe coil skid according to embodiments of the present disclosure;

FIG. 8 illustrates aspects of a pipe coil skid according to embodiments of the present disclosure;

FIG. 9 illustrates aspects of a pipe coil skid according to embodiments of the present disclosure;

FIG. 10 illustrates aspects of a pipe coil skid according to embodiments of the present disclosure;

FIG. 11 illustrates aspects of a pipe coil skid according to embodiments of the present disclosure;

FIG. 12 illustrates aspects of a pipe coil skid according to embodiments of the present disclosure;

FIG. 13 illustrates aspects of a pipe coil skid according to embodiments of the present disclosure;

FIG. 14 illustrates aspects of a pipe coil skid according to embodiments of the present disclosure;

FIG. 15 illustrates aspects of a pipe coil skid according to embodiments of the present disclosure; and

FIG. 16 illustrates aspects of a pipe coil skid according to embodiments of the present disclosure.

### DETAILED DESCRIPTION

Embodiments of the present disclosure relate generally to a pipe coil skid for use in transporting, storing and/or deploying coils of pipe. Coils of pipe may be self supported, for example, using straps or bands to hold coils together, or coils of pipe may be supported around a reel (which may be referred to as a reel of pipe).

Embodiments of the present disclosure will be described below with reference to the figures. In one aspect, embodiments disclosed herein relate to embodiments for pipe coil skids of various sizes configured for use in storage, deployment or transporting coils of flexible pipe to various sites.

As used herein, the term “coupled” or “coupled to” may indicate establishing either a direct or indirect connection, and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

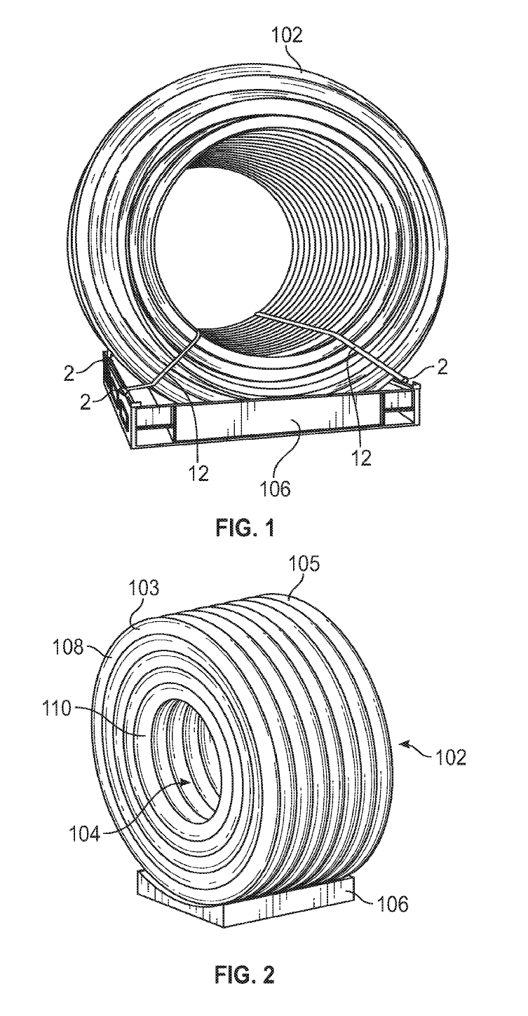

FIG. 1 shows a diagram of a coil of pipe 102 disposed on a pipe coil skid 106, the coil of pipe 102 secured by straps 12 or bands to tie-down points 2 according to embodiments of the present disclosure.

As illustrated in FIG. 2, coil of pipe 102 may be formed by wrapping pipe into a coil with an interior channel 104 formed axially therethrough, where the coil of pipe 102 may be moved as a single package or bundle of coiled pipe, as shown in FIG. 1. Each complete turn of coiled pipe may be referred to as a wrap of pipe. Multiple wraps of pipe in a coil of pipe may be configured in columns along an axial dimension of the coil of pipe and/or configured in layers along a radial dimension of the coil of pipe. For example, multiple columns of wraps may be formed along an axial direction of the coil of pipe, where the axial dimension of the coil of pipe is based on the diameter of the pipe and the number and axial position of wraps forming the coil of pipe 102. Further, multiple layers of wraps may be formed along a radial direction of the coil of pipe, where the radial dimension of the coil of pipe is based on the diameter of the pipe and the number and radial position of the wraps forming the coil of pipe.

As shown in FIG. 2, coil of pipe 102 may be one or more layers (e.g., layers 108 and 110) of pipe packaged or bundled into a larger coil. Coil of pipe 102 may include at least one or more layers of pipe that have been coiled into a particular shape or arrangement. As shown in FIG. 2, coil of pipe 102 is coiled into a substantially cylindrical shape having substantially circular bases 103 and 105 formed on each end of coil of pipe 102, where the axial dimension of coil of pipe 102 is measured between the two bases 103, 105.

A pipe, as understood by those of ordinary skill, may be a tube to convey or transfer any water, gas, oil, or any type of fluid known to those skilled in the art. The pipe used to make up coil of pipe 102 may be made of any type of materials including without limitation plastics, metals, a combination thereof, composites (e.g., fiber reinforced composites), or other materials known in the art.

In one or more embodiments, the pipe used to make up coil of pipe 102 may be a flexible type of pipe. Flexible pipe is used frequently in many applications, including without limitation, both onshore and offshore oil and gas applications. Flexible pipe may include Flexible Composite Pipe (FCP) or Reinforced Thermoplastic Pipe (RTP). A FCP/RTP pipe may itself be generally composed of several layers. In one or more embodiments, a flexible pipe may include a high-density polyethylene (“HDPE”) pipe having a reinforcement layer and an HDPE outer cover layer. Additionally, various types of polyethylene are available for flexible pipe composition. Other polymers may also be used such as nylon, PVDF, Polypropylene and many others. Thus, flexible pipe may include different layers that may be made of a variety of materials and also may be treated for corrosion resistance. For example, in one or more embodiments, pipe used to make up a coil of pipe may have a corrosion protection shield layer that is disposed over another layer of steel reinforcement. In this steel reinforced layer, helically wound steel strips may be placed over a liner made of thermoplastic pipe. Flexible pipe may be designed to handle a variety of pressures. Further, flexible pipe may offer unique features and benefits versus steel/carbon steel pipe lines in the area of corrosion resistance, flexibility, installation speed and re-usability.

Coils of pipe may be made with coil having an outer diameter ranging, for example, from about 2 inches (5.1 cm) to about 10 inches (25.4 cm). However, pipe having other dimensions may be coiled to form a coil of pipe according to embodiments of the present disclosure. Accordingly, pipe that that may be spooled or coiled into coil of pipe 102 may be made to suit a number of dimensions and may have any diameter useful to a particular project.

As known to those of ordinary skill in the art, pipe used to make up coil of pipe 102 may be coiled using spoolers or other coiler machines suited for such a function. Those of ordinary skill will recognize that the present disclosure is not limited to any particular form of coiler or other device that may be used to form pipe into a coil. Coiling pipe into a coil of pipe, such as 102, assists when transporting pipe, which may be several hundred feet in length in one or more embodiments. Further, coil of pipe 102 may be assembled as a coil to facilitate deployment of the coil. Deployment, as described above and used herein, may refer to the action of unspooling or unwinding the pipe from coil of pipe 102.

After being assembled into a coil, coil of pipe 102 may include an interior channel 104 formed axially through the coil of pipe 102. Interior channel 104 is a bore disposed generally in the center of coil of pipe 102. Interior channel 104 is substantially circular shaped. The coil of pipe 102 may have an outer diameter (OD) and an inner diameter (ID), where the inner diameter is defined by the interior channel.

In one or more embodiments, coil of pipe 102 may have an outer diameter ranging from about 60 inches (1.5 m), which may occur, for example, when coil of pipe 102 has at least two layers of 2 inch pipe, to about 192 inches (4.9 m). In one or more embodiments, a coil of pipe may have an inner diameter ranging, for example, from about 84 inches (2.1 m) to about 126 inches (3.2 m). Further, in one or more embodiments, a coil of pipe may have an axial dimension (width) ranging from about 5 inches (12.7 cm) to about 92 inches (2.3 m). However, these are merely exemplary measurements. Those of ordinary skill in the art will appreciate that any range of dimensions (inner and outer diameters and width) may be accommodated using one or more embodiments.

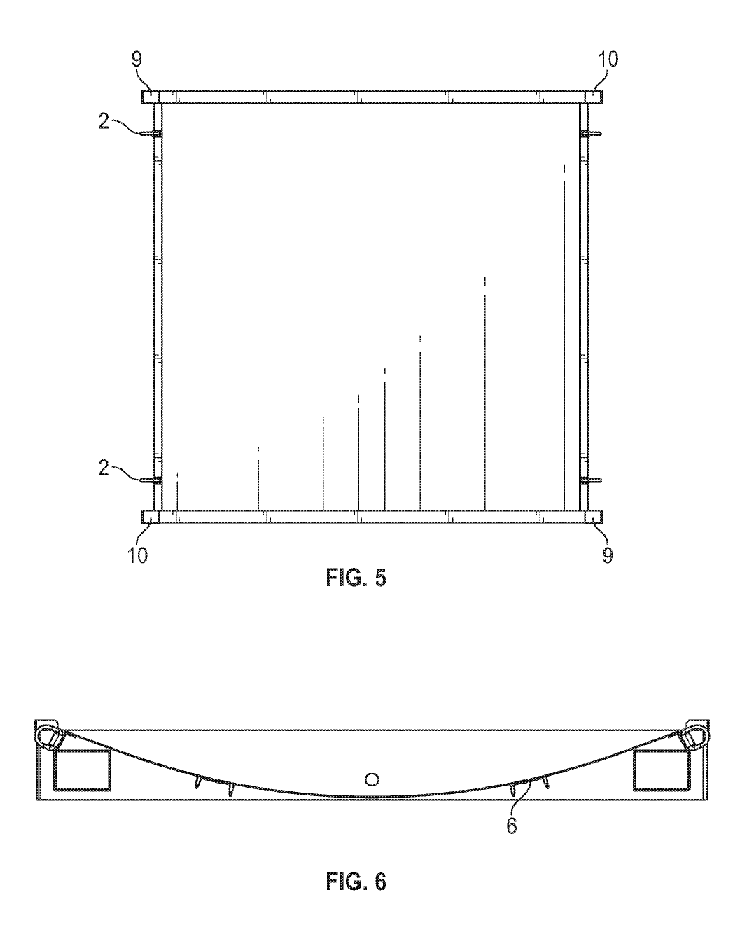

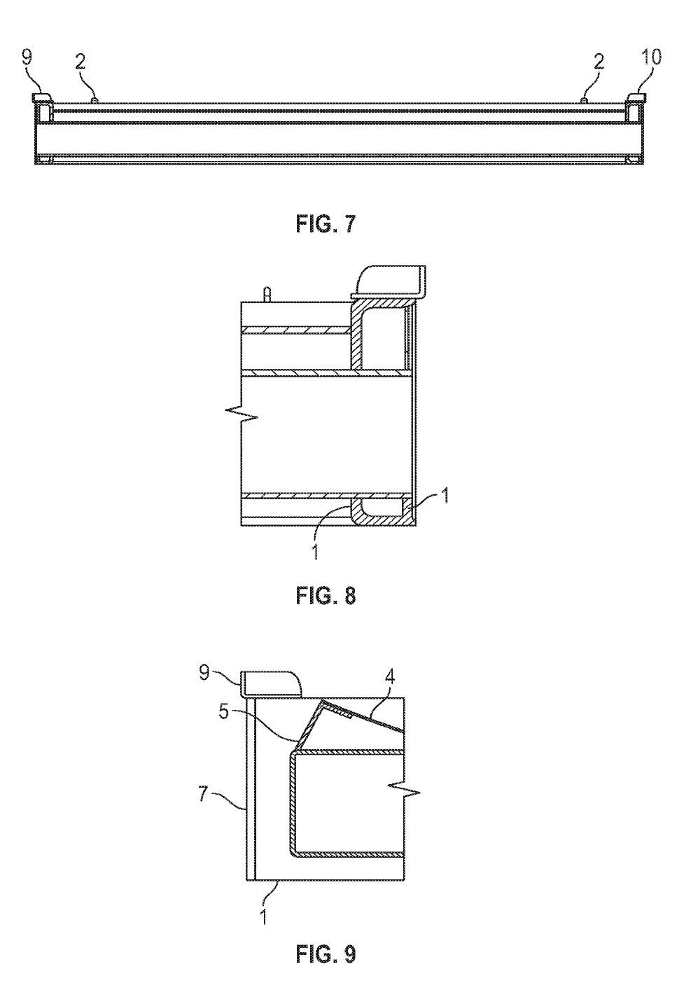

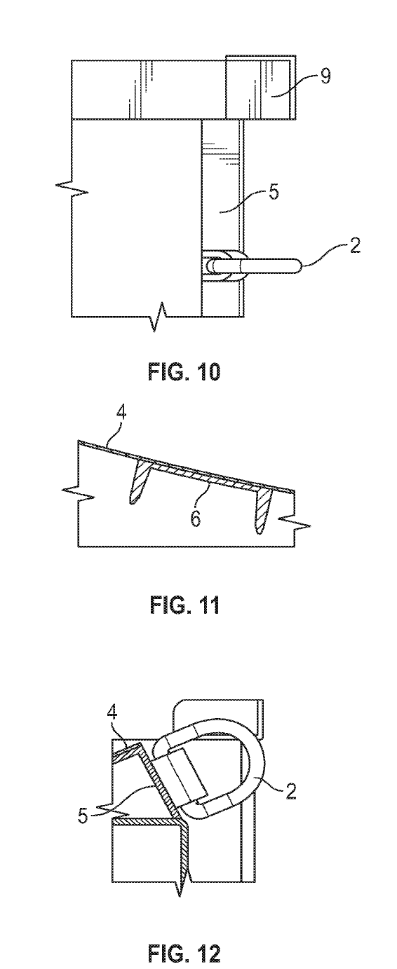

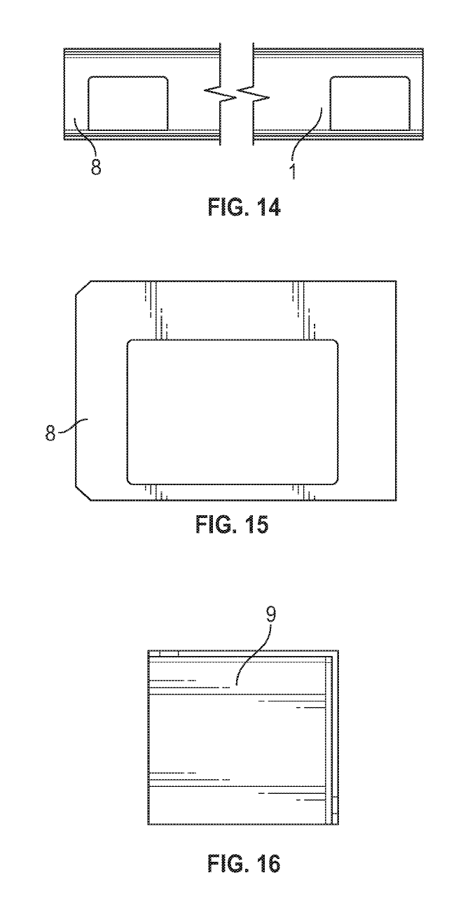

Various illustrative embodiments of skid 106 and its related equipment and information are shown in FIGS. 1-16 herein. Skid 106 illustrated in FIGS. 1-16 may comprise a platform 4 upon which coil of pipe 102 may be disposed to hold the coil of pipe 102 in a vertical orientation. In one or more embodiments, coil of pipe 102 may be moved and secured while remaining on skid 106.

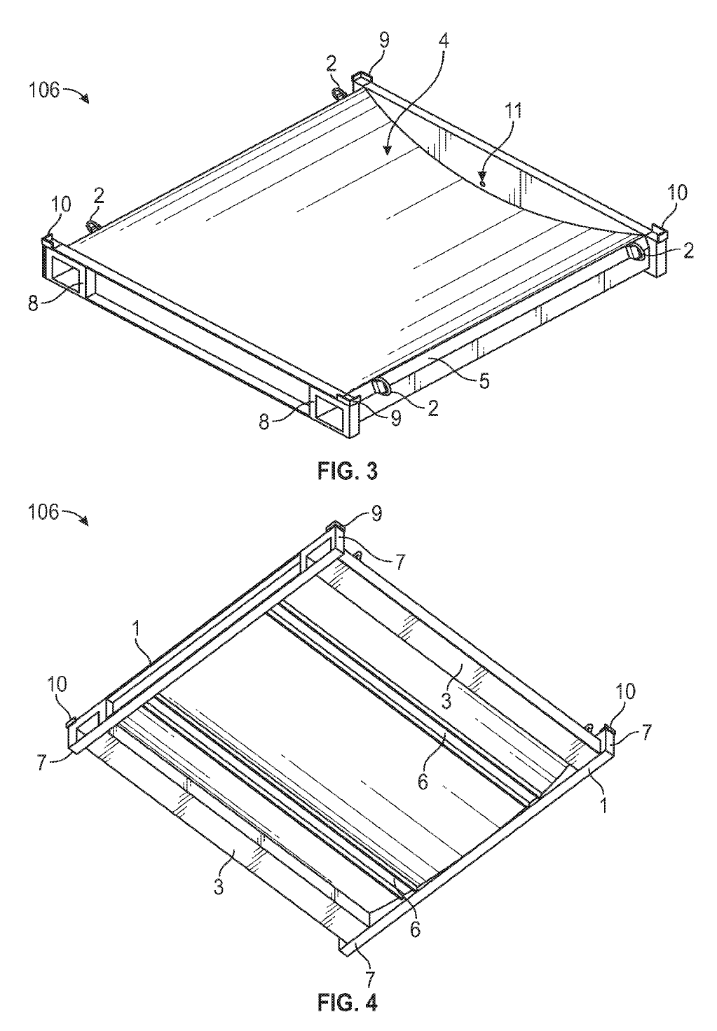

As illustrated in FIG. 3 and FIG. 4 according to certain illustrative embodiments, skid 106 can be formed of a plurality of beams 1, 3, 6, 7 and 8 that are affixed together to form a rectangular shaped base. In certain illustrative embodiments, the base may be square shaped. A platform 4 sits within the base. The platform 4 can have a concave curvature shape on its upward facing side (when skid 106 sits on a horizontal surface) that generally corresponds to the outer circumferential shape of a coil of pipe, such that when the coil of pipe sits within the base of the pipe coil skid 106, it is generally flush with the platform 4. However, the above description should not be deemed limiting with respect to the shape, construction or application of skid 106, as skid 106 may have any shape, construction and/or application that is within the scope of the description and figures herein. The pipe coil skid 106 may contain weep holes 11, for example through beam 1, see FIG. 3, to aid in the removal of water from the interior of the skid.

Additionally, as illustrated in FIG. 4 and FIG. 6, the platform 4 may have attached a plurality of u-channels 6 or u-beams as further supporting structure. Larger skids 106 will have more u-channels 6, for example the skid 106 in FIG. 1. A cross section detail of this u-channel 6 structure is illustrated in FIG. 11. In certain cases, beams may be other structural shapes, for example, rectangular tube, square tube, I-beam, T-beam, or other common structural forms.

In certain illustrative embodiments, skid 106 can be formed of a metal material. For example, the metal material can be A572/GR 50 high strength, low alloy columbium vanadium structural steel. Any metal capable of supporting 40 klbs. loads may also be used including equivalent available metals such as ISO spec metal, ASTM and AISI metals.

In certain illustrative embodiments, the metal skid can be constructed of structural steel components such as c-channels, angle iron, or sheet metal that are welded together. The skid can be utilized to secure the coil of pipe so that it does not roll away or get damaged during storage and/or transport.

In certain illustrative embodiments, the platform and/or other parts of the metal skid can be coated with a non-stick material, and/or rubberized material, or otherwise have a non-stick surface such that the coil of pipe is prevented from slipping off of the skid.

In certain illustrative embodiments, skid 106 may be sized with an upward facing concave surface to support a coil of pipe that may have an outside diameter (OD) of about 192 inches and a weight of about 40 klbs. However, skid 106 can be sized as needed to transport different sizes and/or weights of coiled pipe.

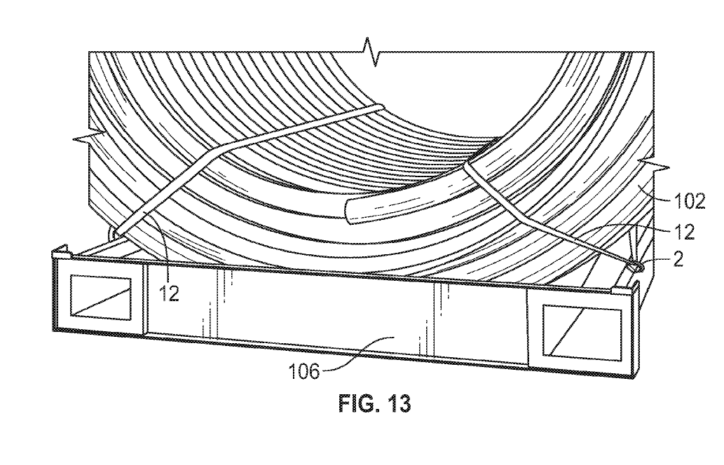

Also with respect to FIGS. 3 and 4, skid 106 can have one or more fork pockets or channels 8 so that skid 106 can be lifted and moved with a forklift (see, e.g., FIGS. 3-4). Skid 106 may also have one or more tie-down points 2 (such as lashing rings, see FIGS. 3, 5, 7, 10 and 12) disposed thereon to secure the coiled pipe 102 to the skid 106 with, for example, straps 12 (see, e.g., FIGS. 12, 13 and 1). The tie down points 2 may be disposed on angled surface 5 that meets platform surface 4 (see, e.g., FIG. 12). Skid 106 may also have stackable corners 9, 10 so that the skids can be stacked during transport or storage (see, e.g., FIGS. 3-10 and 16). The stackable corners 9, 10 can also be designed to fit securely within the brackets on a rail trailer so that the skid (or stack of skids) will be secured to the trailer during rail transport. Skid 106 can also be sized such that it can fit in a standard over-seas shipping container.

FIG. 13 shows a pipe coil 102 secured to a pipe coil skid 106 with straps 12. FIG. 1 illustrates a pipe coil 102 on a pipe coil skid 106. It should be appreciated that a pipe coil 102 with a pipe coil skid 106 attached may be moved using a fork lift or crane that is not in contact with the pipe coil skid. At the same time, the coil 102 with skid 106 package could be lifted via skid pockets with adequately sized pocket dimensions assuming a lift with adequate weight capability is used. Skid design may be limited due to space availability under the support surface of the skid and still ensure the overall package size fits with standard cargo containers.

Numerous benefits and advantages may be provided as a result of the one or more embodiments of a steel pipe coil skid 106 as described in the present disclosure. For example, in certain illustrative embodiments, skid 106 can have a size, shape and construction that is acceptable by freight railroad transportation providers to safely handle the 2 g and 3 g loading requirements for shipping large, heavy items on the rail. Skid 106 having a metal construction is especially suited for transporting the coil of pipe 102 by rail. Prior art skid designs made of wood could not be transported by rail because they could not meet these 2 g lateral and 3 g longitudinal loading requirements. In addition, while rail transportation often requires hardwood construction of transportation skids, which is costly, the metal fabricated design is overall cheaper and stronger.

For example, when a reel is not utilized, i.e., reel-less pipe, the coil of pipe 102 can include a very long length of wound piping and be heavier (and longer) than reeled pipe. Certain customers may desire that pipe 102 not be coiled onto a reel because reels must then be stored and/or returned to the supplier after the pipe 102 is removed. Skid 106 may also be transported by truck, train or ship, if desired. Thus, skid 106 is multi-modal in certain illustrative embodiments.

In certain illustrative embodiments, one or more brackets can be utilized on or near the rails of the railcar to further secure skid 106 to the railcar. In certain illustrative embodiments, the brackets can be positioned on both sides of skid 106 to provide support on each side, and pressed tightly against skid 106 such that movement of skid 106 is restricted. The brackets can have a length that is the same length as, or substantially the same length as, the skid, or alternatively, one or more shorter brackets can be utilized along the length of the skid.

In one nonlimiting embodiment a pipe coil skid comprises a plurality of beams affixably connected together to form a rectangular shaped base with a platform disposed within the base, the platform having a concave upward shape on its upward facing side when the skid sits on a horizontal surface such that the coil of pipe positioned upon the platform contacts the platform within the base. In other aspects, the pipe coil skid has an upward facing side generally corresponding to the outer circumferential shape of a coil of pipe. The beams and the platform may be formed of a steel material. The platform may be coated with a non-stick material or a rubberized material. The pipe coil skid may have a plurality of tie-down points for securing the coil of pipe. The pipe coil skid may have stackable corners disposed on the skids to enable stacking of pipe coil skids. The pipe coil skid may contain weep holes to aid in the disposal of moisture.

In another embodiment, a method for using a pipe coil skid provides for securing a coil of pipe to a pipe coil skid. The skid comprises a plurality of beams affixably connected together to form a rectangular shaped base, and a platform disposed within the base, the platform having a concave upward shape on its upward facing side when the skid sits on a horizontal surface, such that the coil of pipe positioned upon the platform contacts the platform within the base.

Other aspects of the method include lifting the coil of flexible pipe with a pipe coil lifting device using a fork lift or a crane. The pipe coil skid secured to the pipe coil may have an upward facing side generally corresponding to the outer circumferential shape of a coil of pipe. The beams and the platform of the pipe coil skid are formed of a steel material. The platform may coated with a non-stick material or a rubberized material. The method may include securing the pipe coil to the skid using straps. The method may further include securing the pipe coil skid to a rail car.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed is:

1. A pipe coil skid, comprising; a plurality of beams affixably connected together to form a rectangular shaped base; and a platform disposed within the base, the platform having a concave upward shape on its upward facing side when the skid sits on a horizontal surface, such that a coil of pipe positioned upon the platform contacts the platform within the base.

2. The pipe coil skid of claim 1 wherein the upward facing side generally corresponds to the outer circumferential shape of a coil of pipe.

3. The pipe coil skid of claim 1 wherein the beams and the platform are formed of a steel material.

4. The pipe coil skid of claim 1 wherein the platform is coated with a non-stick material.

5. The pipe coil skid of claim 1 wherein the platform is coated with a rubberized material.

6. The pipe coil skid of claim 1 further comprising a plurality of tie-down points disposed upon the skid for securing the coil of pipe.

7. The pipe coil skid of claim 1 further comprising stackable corners disposed on the skids to enable stacking of pipe coil skids.

8. A method for using a pipe coil skid comprising: securing a coil of pipe to a pipe coil skid, the skid comprising a plurality of beams affixably connected together to form a rectangular shaped base, and a platform disposed within the base, the platform having a concave upward shape on its upward facing side when the skid sits on a horizontal surface, such that the coil of pipe positioned upon the platform contacts the platform within the base.

9. The method of claim 8 further comprising lifting the coil of flexible pipe using at least one selected from the list consisting of i) a pipe coil lifting device disposed on a fork lift, ii) a pipe coil lifting device secured by cable to a crane, iii) an installation trailer for coiled pipe, and iv) an expandable drum assembly for deploying coiled pipe.

10. The method of claim 8 wherein the pipe coil skid comprises an upward facing side generally corresponds to the outer circumferential shape of a coil of pipe.

11. The method of claim 8 wherein the pipe coil skid wherein the beams and the platform are formed of a steel material.

12. The method of claim 8 wherein the pipe coil skid wherein the platform is coated with at least one selected from the list consisting of i) a non-stick material and ii) a rubberized material.

13. The method of claim 8 wherein the pipe coil is secured to the pipe coil skid using straps.

14. The method of claim 8 further comprising securing the pipe coil skid to a rail car.

15. The method of claim further comprising stacking a plurality of pipe coil skids.
